(19) United States
(12) Patent Application Publication
(10) Pub. No.: US 2002/0056097 A1
(43) Pub. Date: May 9, 2002

(54) Multimedia feature article for global network viewing

(76) Inventors: Larry J. Marion, Newton, MA (US); Evan B. Schuman, Whippany, NJ (US)

Correspondence Address: Mary Lou Wakimura, Esq., HAMILTON, BROOK, SMITH & REYNOLDS, P.C., Two Militia Drive, Lexington, MA, 02421-4799, US

(21) Appl. No.: 09/826,795

(22) Filed: Apr. 5, 2001

Related U.S. Application Data
(60) Provisional application No. 60/195,490, filed on Apr. 10, 2000.

(51) Int. Cl. G06F 3/00

(52) U.S. Cl. 725/38

(57) ABSTRACT

The present invention provides multimedia Web page articles. That is, the present invention combines audio and/or animation and/or video, with text to form multimedia feature articles for Web pages. Respective links for the desired audio, video and/or animation are embedded in the text of the feature article. The links point to respective executable files of the digitally stored rendition of the desired audio, video and/or animation.

### RELATED APPLICATION

This application claims the benefit of U.S. Provisional Application No. 60/195,490 filed Apr. 10, 2000, the entire teachings of which are incorporated herein by reference.

### BACKGROUND OF THE INVENTION

The World Wide Web global network is a rich source of information. Various content providers, merchant sites and other information bearing sites form nodes of the network. End-user's computers use browser software and/or Internet service providers to connect to the various network nodes via communication lines such as telephone lines or a cable network. Once connected, the various network nodes serve as sources of a wide variety of information for end-users.

Each node (or Web site) renders Web pages for end-users to view. Web pages are typically text documents in HTML (Hyper Text Markup Language) with embedded links that point to another Web page at the same or a different Web site. If a user activates a link (by selecting it via a cursor control device, e.g., mouse, keyboard command), the screen view changes to the associated Web page/Web site. In this way, the user is enabled to navigate or “surf” the Web (Internet) and experiences the viewing of a wealth of information.

### SUMMARY OF THE INVENTION

The present invention adds another dimension to the Web experience of viewing Web pages. The present invention provides multimedia Web page articles. That is, presentations formed of text with any combination of audio, animation and/or video are provided in Web pages by the present invention.

More importantly Applicants have discovered for a given topic, different points in a presentation on that topic are more efficiently conveyed in different respective media. Thus, Applicants provide a method for forming presentations using one medium (e.g., text, audio, video, animation, graphics) to convey one portion and a different medium to convey another portion of the presentation and so on.

In the preferred embodiment, the invention method for providing a multimedia presentation in a computer system includes the steps of

preparing a story script on a current subject to be covered in a desired presentation,

of that story script, determining certain portions for producing graphics or animation in the presentation, determining other portions for use in at least one video recording or audio recording for the presentation, and remaining portions to provide text for the presentation;

video recording (or audio recording) a speaker or demonstration which employs the determined other portion of the story script and is directed to an audience of the desired presentation;

using digital means, producing graphics or animation following the determined certain portions of the story script;

preparing a text file containing the remaining portions of the story script in text; and

combining the audio recording, video recording (with or without audio), graphics or animation and text files in story script order, to form a computer executable file producing the desired presentation, such that upon a digital processor executing the computer executable file, the presentation having video, graphics, animation and text is digitally rendered and displayed.

The step of determining other portions includes determining parts of the story script which are efficiently conveyed by an interview or demonstration. Further, the step of determining certain portions includes determining certain parts of the story script which are more easily understood with the assistance of a visual aid.

A digitally rendered multimedia presentation formed by the foregoing steps is the resulting invention product.

Accordingly, in a computer network, a multimedia article of the present invention covering a desired topic comprises (i) a text portion, (ii) at least one video and audio clip from a video recording of a speaker or demonstration directed to end users of the network on the desired topic, and (iii) a graphically illustrated part. Each of the text portion, video and audio clip and graphically illustrated part recite a respective section of a story script covering the desired topic, and each is digitized in story script order in a computer executable file. Upon a digital processor executing the computer executable file, a multimedia article having text, video, audio and graphics covering the desired topic is digitally rendered and displayed.

The respective section of the story script recited by the video and audio clip is more efficiently conveyed by a speaker or demonstration than by text or a graphic illustration. Similarly the respective section of the story script recited by the graphically illustrated part is more easily understood with the assistance of a visual aid.

In accordance with one aspect of the present invention, the computer executable file is executable on multiple nodes of the computer network such that the multimedia presentation is widely accessible.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a preferred embodiment of the present invention.

FIG. 2 is a flow diagram of the method employed to generate the embodiment of FIG. 1.

### DETAILED DESCRIPTION OF THE INVENTION

With the advent of the Internet, digital information has taken the form of both audio and visual media. Combinations of text, audio, video, graphics and/or animation in a subject presentation have become known as “multimedia”. Applicants' method and product make the most of multimedia presentations by utilizing, for a respective portion of the presentation, the medium that is most efficient in conveying a respective point of that portion of the presentation. Specifically, for a given presentation on a certain topic, one portion is in text where text is efficient in conveying the message of that portion, another portion is in video where video is the medium most efficient at conveying that portion, and so forth.

Heretofore the prior art relies on prior existing videos and visual aids and combines such with new or current text to form a multimedia presentation. Typically the collective result provides portions that are a historical account of a subject/topic or portions in which the speaker is originally addressing a past audience (and not the current end user of the resulting multimedia presentation). Thus, these portions while providing a visual aid and variation to the text, do not take advantage of the efficiencies in communicating different pertinent points using different respective media as in the present invention.

In addition, prior art also requires enormous bandwidth and extremely expensive production costs.

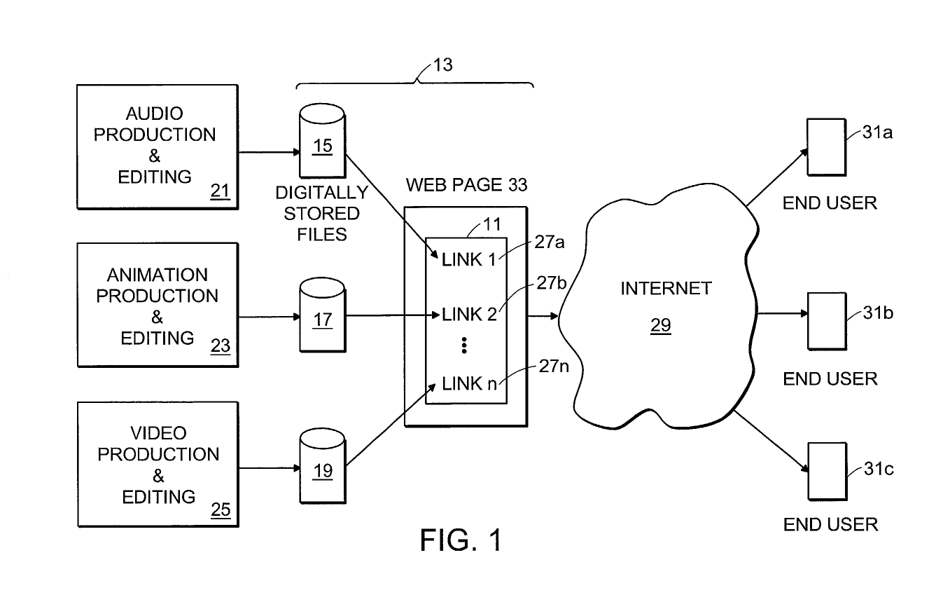

The present invention is illustrated in general terms in FIG. 1. By way of overview, the present invention combines digital files 15, 17, 19 of an audio track and/or video and/or animation, in any combination, with text to form a multimedia Web page feature article 11. The feature article 11 is viewable or rendered from a host Web site (server computer) 13 coupled through the Internet or global network of computers 29 to various end users 31. End user computers 31 log onto Web site server 13 and view the feature article 11 through one or more Web pages 33 of host Web site 13. The invention Web page article 11 is formed as follows.

Generally, a desired audio track 15 is produced and edited (such as at 21 in FIG. 1) from interviews, source audio and the like. The editing includes clipping the audio to a length of time that is suitable for the Web page presentation 11. Similarly animation and/or video clips 17, 19 desired are produced and edited as illustrated at 23 and 25 in FIG. 1. Next the text and layout of other visuals for the Web page article 11 are produced and include associating a respective link 27 to each audio portion 15 and/or animation clip 17 and/or video clip 19 desired. Specifically, representations of links 27 are inserted into desired locations in the text/visual layout, such that upon end-user selection of a link 27 (representation of the link as embedded in the text) via a cursor control device (click of a mouse, keyboard command and the like), the associated audio portion 15, animation 17 or video 19 is played (“playback”), rendered or otherwise displayed through a sound system and/or display monitor coupled to the end user's computer 31.

It is understood that the subject audio, animation and video are preferably in digital format and stored in respective working files 15, 17, 19 accordingly, using techniques known in the art. Likewise, known linking techniques are utilized to associate the digital files 15, 17, 19 (audio and/or video and/or animation) with the link representation 27 embedded in the text layout of the Web page article 11. Hyper Text Transfer Protocol or other suitable protocol is employed for transmitting Web pages 33 from Web site 13 and for supporting communications between or otherwise coupling Web site 13 to end users nodes 31 across Internet 29.

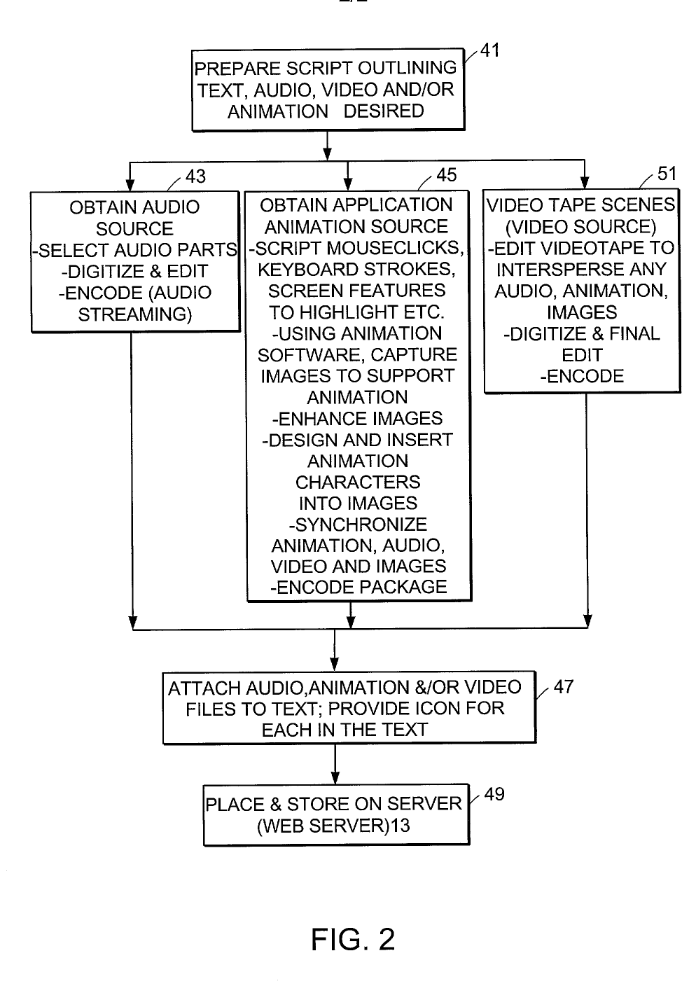

In more particular details, FIG. 2 outlines the process employed in the preferred embodiment. Three types of multimedia feature articles (or presentations) 11 for Web pages 33 are detailed. A text with audio article 11 is discussed first, with respect to the left side of FIG. 2. A text with audio and animation Web page article 11 follows the first discussion and refers to the center column of FIG. 2. Lastly, a text with audio, animation and video Web page feature article 11 is discussed with reference to the right hand side of FIG. 2.

Straight Text Story with User Audio

Given a subject topic, a narrative story outline is prepared as a word processing document (step 41 of FIG. 2). Included are the contents of a story line, URL's for hyperlinks, indications for photographs, video clips, audio clips and other visual effects. Writers prepare and review the finished text stories formed from the narrative outline and reporters'/researchers' notes. The producer/writers also select those story portions and human subjects (i.e., presenters) where audio is likely to work best at conveying the point of that portion. For the selected portions, potential scripts for the presenters are written based on their comments in the story plus a review of reporter's notes. The resulting scripts and storyboard are stored as word processing documents that resemble screen write manuscripts. Appendix I is illustrative of the script and storyboard for a presentation on the use of audio track editing software sold under the name Sound Forge.

At step 43 (FIG. 2), following the prepared scripts, an audio interview with the presenter (or appropriate key source) on analog cassette tape is conducted. The cassette tape recording is played back/reviewed for selection of the sound cuts (called actualities) that work best. These sound cuts are digitized and edited on a computer, for example using Sound Forge 4.5 by Sonic Foundry of Madison, Wisconsin. The editing allows for removing “uhs” and “umms” plus deleting portions that are irrelevant. The editing also adjusts the volume levels, increases/decreases background noise, shortens over-long pauses or adds pauses in, etc. Once edited, the actualities are encoded in the audio streaming technology that is to be used (RealAudio, MediaPlayer, etc.) by host server 13 and are stored in digital working files 15.

At step 47 (FIG. 2), a Web authoring team is next instructed on how and where to attach the prepared audio file 15 to text. An appropriate icon is developed and utilized in the text to indicate the audio component. The text is also converted to HTML for Web transmission. The finished text combined with audio product (multimedia article 11) is placed and stored on server 13 as digitally executable Web/processor files as illustrated at step 49 (FIG. 2).

Straight Text Story with User Audio and Animation

Given a subject topic, a narrative story outline is prepared as above described at step 41 and audio selection, editing and encoding of desired audio portions is as discussed at step 43 above.

From a review of the finished text stories and working scripts, portions to be animated are selected. Again selection is based on the message to be conveyed by animation being more efficiently conveyed in that manner than by an audio clip, video or other medium. For the selected animation portion, an exact script (for the animation team) is written (step 45 of FIG. 2). This script details what keystrokes and mouse clicks are required to recreate each presenter example, which features or screen attributes should be highlighted with an animated device (arrow, etc.) and other specific details to create the animation portion. The animation team recreates the presenter's examples following the script and using standard off the shelf animation tools. These animation tools enable the animation team to enhance images and add motion, so that a pulldown menu will automatically pull down on cue, for example and to design and insert animation characters (arrow or other device) that points to specific features or functions. One such animation editing software is Avid Media Composer 1000XL by Avid Technology, Inc. of Tewksbury, Mass. Other such software is suitable.

Next (continuing step 45), the animation team synchronizes the animation with the presenter's verbal cues and with the text, so that when the presenter talks about a part of the screen (such as “as you can see here, all of the new quarterly projections are displayed and it's really easy to compare them with the old quarterly projections, which appear right next to them . . . over here . . . in blue.”), the animation device points to and performs the action described. The resulting animation package is encoded and stored in respective files 17 (end of step 45).

The audio 15, animation 17 and final text files in HTML format are appropriately linked together or otherwise attached at step 47 and form the feature article product 11. At step 49, product 11 is stored on server 13 for execution/use over the Web as described above.

Straight Text Story with Audio, Animation and Video

Given a subject topic for discussion in a presentation, a narrative story outline is prepared. From researchers' notes and reporters' findings, writers prepare finished text stories and identify appropriate potential multimedia candidates. Writers/producers review the finished text stories and select those story portions and candidates for audio/ video and animation where effective and efficient to convey the various respective points of the subject topic. For the audio and animation portions, steps 43 and 45 are followed as discussed above. For the video portions, a storyboard is written and includes a description of each scene, script that the speaker is to follow and indications of multimedia insertions.

Step 51 involves going on desired location and videotaping the candidate speaker following the written storyboard and prepared script. The resulting video tape recording is then reviewed and edited to intersperse the speaker interview with the technology images (visual effects) and to identify appropriate animation inserts. Next, the edited video tape is digitized, finally edited and encoded as working file 19.

Avid Media Composer 1000XL by Avid Technology, Inc. of Tewksbury, Mass. is employed in the preferred embodiment but other editing and encoding software is suitable.

The final text, audio, animation and video files 15, 17, 19 are linked or attached together (step 47) in HTML to form feature article product 11 which is ultimately stored as executable files on server 13 (step 49).

While this invention has been particularly shown and described with references to preferred embodiments thereof, it will be understood by those skilled in the art that various changes in form and details may be made therein without departing from the scope of the invention encompassed by the appended claims.

For example, the present invention avoids the current industry trend of employing preexisting clips (audio, video, etc.) and search engines for locating the same to provide a collective presentation on a topic. Instead the present invention produces each story portion from “scratch”, i.e., using originally written scripts, analogue capturing devices such as audio tape recorders, video camera recorders and the like and editing tools/software. Piecing together a presentation in this manner is opposite the prior art which takes advantage of preexisting pieces and the wealth of and speed at which information is available on the Web. Restated, the present invention seeks to provide more information (i.e., add) to the Web but in a format conducive to learning about a topic instead of quickly pulling together preexisting information from the Web to inform one about a subject topic.

In this way, the presentations of the present invention are in a consistent grammatical tense and speak to the end user directly, whereas the prior art methods produce presentations of mixed or varied grammatical tense with portions initially focused to different audiences/parties than the end user.

As such the present invention may be considered a method and apparatus for teaching, as well as presenting topical subject matter efficiently using multimedia and the Internet. Such is heretofore unachieved by the prior art.

As used herein, the present invention is efficient in communicating and illustrating points of information which is distinguished from efficiency in accessing and providing information. The latter is the current focus of the state of the art which overlooks the finer techniques of improved communication (conveyance of a message) behind the present invention.

### APPENDIX I

TIME: APPROXIMATELY 0 (MIN):00 (SEC.) THROUGH 0:10.

VISUAL: A BLACK BACKGROUND, WITH THE LOGO OF THE COMPANY (we can use the STEC logo, for the same of the demo). THE NAME OF THE COMPANY (PARALLELOGRAM PUBLICATIONS), A PHOTOGRAPH OF THE USER INTERVIEWEE (we can use a stock photograph) AND TEXT OF THEIR NAME AND TITLE (Barry Johnson, IT Administrator)

AUDIO: VOICE OF THE PRESENTER (When the word came down that we were going to deliver a lot of our training on our Intranet, we realized that some of us here had better learn how to digitize and edit audio. The first thing we realized when . . . )

TIME: APPROXIMATELY: 0:10 THROUGH 0:20

VISUAL: THE BLACK BACKGROUND REMAINS, BUT THE TEXT DISSOLVES INTO THE OPENING SPLASH SCREEN FOR SOUND FORGE 4.5.

AUDIO: VOICE OF THE PRESENTER ( . . . we started playing with Sound Forge 4.5, was that it was quite intuitive. To get started and to do the very basics, it took virtually no prep time . . . )

TIME: APPROXIMATELY: 0:20 THROUGH 0:30

VISUAL: THE SCREEN DISSOLVES OR CUTS (animator's discretion) TO A FULL SCREEN CAPTURE OF THE WORKPAGE. (I'll identify that page later. It's hard to explain until the application is seen.) IDEALLY, WE'D LIKE TO HAVE A SMALL ANIMATED CHARACTER (similar to the wizard we discussed) WHO WOULD SILENTLY POINT AND REFERENCE PARTS OF THE SCREEN. LET'S TALK ABOUT WHETHER THAT WOULD BE A MAJOR COST ELEMENT OR NOT. I'D LOVE TO HAVE IT, BUT IF IT MAKES ENOUGH OF A PRICE DIFFERENCE, IT MIGHT NOT BE NEEDED. IT WOULD JUST BE EYE CANDY.)

AUDIO: VOICE OF THE PRESENTER ( . . . But we also realized that. well. the developer giveth and the developer taketh away. The price we paid for that initial ease-of-use is that the more advanced features assume much user knowledge . . . )

TIME: APPROXIMATELY: 0:30 THROUGH END OF PIECE

VISUAL: (We'll try and sketch this out as precisely as practical, but the big picture direction here is that the screen will demo what the application will look like as the presenter describes it. Liberal use of colored circles—where the viewer will see the circle being drawn by an invisible hand—would be perfect.) The screen capture here will shrink to half-screen and a simple sketch of a tape recorder will appear next to it. Surrounding the screen capture will be the outline of a PC. As the voice indicates, an animated cable will appear, . . . it will plug into the tape recorder and will then plug its other end into the PC.

AUDIO: VOICE OF THE PRESENTER ( . . . Let's try something simple. Let's take a simple 10-second piece of a recording of our chief developer. We taped in on a good quality analog cassette tape recorder. We have connected the tape recorder into the port of our PC's soundcard. As we lay the tape, it plays both in the tape recorder's speakers as well as the PC's speakers. This has the comforting effect of verifying that the sound is indeed getting into the PC . . . )

VISUAL: An animated finger hits the play button on the tape recorder.

AUDIO: (VOICE OF THE PRESENTER'S SAMPLE EXECUTIVE:) “We . . . uh . . . strongly believe that . . y'know . . . customers around the world . . . (pause) . . . need scalability more than any other feature. (pause) There is simply far too much uncertainty where some projects may head.”

(VOICE OF THE PRESENTER) Once we get the tape to the approximate beginning of our 10-second targeted piece of sound . . . we then tell SoundForge to create a new piece . . . we tell it to be prepared to record . . . and then we tell it to record and then tell the tape recorder to play.

When we're done, we stop the recording.

VISUAL: Screen buttons are circled and then depressed.

AUDIO: (VOICE OF THE PRESENTER) It's now being digitized. Let's play it back and see what it sounds and LOOKS like.

VISUAL/AUDIO: The play button on the screen is circled and then clicked. The screen displays the image playing as the audio plays it as well.

AUDIO: (VOICE OF THE PRESENTER) Once we get the tape to the approximate beginning of our 10-second targeted piece of sound . . . we then tell SoundForge to create a new piece . . . we tell it to be prepared to record . . . and then we tell it to record and then tell the tape recorder to play. When we're done, we stop the playback.

VISUAL: After the selection has been played, the screen capture resumes its full-screen status, which it retains for the duration.

AUDIO: We can now edit the cut, if we'd like. Let's first play it through and see how it sounds and looks. Here's where we can see the waveform of the sound and here's where we can keep an eye on its length. Here, I'd like to remove the “uh” and “ummm” and to delete that awkward pause.

VISUAL: The “uh” and the “ummm” are circled.

AUDIO: First . . . let's just select the part of the selection where that “uh” was. Now let's magnify the selection a bit for easier editing. And THERE is our suspect “uh”. To make absolutely certain that we're not accidentally deleting more than we want, let's play that part. (pause) Sounds good. And we simply delete it by hitting the delete button. Best of all, we can repeatedly undelete, which is good because mistakes and me are old friends.

Now we can go in find that “ummm” and the pause and do the same.

And that's it.

What is claimed is:

1. A method for providing a multimedia presentation in a computer system, comprising the steps of:
preparing a story script on a current subject to be covered in a desired presentation,
of that story script, determining certain portions for producing graphics or animation in the presentation, determining other portions for use in at least one audio recording for the presentation or one video recording for the presentation, and remaining portions to provide text for the presentation;
audio recording, or audio and video recording a speaker or demonstration which employs the determined other portion of the story script and is directed to an audience of the desired presentation;
using digital means, producing graphics or animation following the determined certain portions of the story script;
preparing a text file containing the remaining portions of the story script in text; and
combining the audio recording, audio and video recording, graphics or animation and text files in story script order, to form a computer executable file producing the desired presentation, such that upon a digital processor executing the computer executable file, the presentation having audio, video, graphics, animation and text is digitally rendered and displayed.

2. A method as claimed in claim 1 wherein the step of determining other portions includes determining parts of the story script which are efficiently conveyed by an interview or demonstration.

3. A method as claimed in claim 1 wherein the step of determining certain portions includes determining certain parts of the story script which are more easily understood with assistance of a visual aid.

4. A digitally rendered multimedia presentation formed by the steps of claim 1.

5. In a computer network, a multimedia article covering a desired topic, the multimedia article comprising:
a text portion;
at least one video and audio clip from a video recording of a speaker or demonstration directed to end users of the network on the desired topic; and
a graphically illustrated part, each of the text portion, video and audio clip and graphically illustrated part reciting a respective section of a story script covering the desired topic and each being digitized in story script order in a computer executable file, such that upon a digital processor executing the computer executable file, a multimedia article having text, video, audio and graphics covering the desired topic is digitally rendered and displayed.

6. A multimedia article as claimed in claim 5 wherein the respective section of the story script recited by the video and audio clip is more efficiently conveyed by a speaker or demonstration than text or a graphic illustration.

7. A multimedia article as claimed in claim 5 wherein the respective section of the story script recited by the graphically illustrated part is more easily understood with assistance of a visual aid.

8. A multimedia article as claimed in claim 5 wherein the computer executable file is executable on multiple nodes of the computer network such that the multimedia presentation is widely accessible.
